(19) United States
(12) Patent Application Publication
(10) Pub. No.: US 2020/0385233 A1
(43) Pub. Date: Dec. 10, 2020

(54) METHOD FOR OPERATING A LIFT SYSTEM

(71) Applicant: THYSSENKRUPP ELEVATOR INNOVATION AND OPERATIONS GMBH, Essen (DE)

(72) Inventors: Richard THUM, Kornwestheim (DE); Eduard STEINHAUER, Nürtingen (DE); Marius MATZ, Filderstadt (DE)

(73) Assignee: thyssenkrupp Elevator Innovation and Operations GmbH, Essen (DE)

(21) Appl. No.: 16/328,599

(22) PCT Filed: Aug. 24, 2017
(86) PCT No.: PCT/EP2017/071339

§ 371 Date: Feb. 26, 2019

(30) Foreign Application Priority Data
Aug. 31, 2016 (DE) 10 2016 216 369.8

(51) Int. Cl. B66B 1/30; B66B 11/04; B66B 5/02; H02P 25/064

(52) U.S. Cl. CPC B66B 1/308; H02P 25/064; B66B 5/02; B66B 11/0407

(57) ABSTRACT

A method for operating a lift system includes a lift cage movably housed movably inside a lift shaft. A linear drive is configured to drive the lift cage, the linear drive includes a stator arrangement fixedly attached to the lift shaft with a plurality of stators and a rotor attached to the lift cage. The stator arrangement includes electromagnetic coils, each of the coils configured to be operated by one phase of a polyphase alternating current. The method includes providing the polyphase alternating current to operate the stator arrangement and thereby drive the lift cage to generate an upward force for the lift cage, monitoring a deceleration value of the lift system with sensors that are permanently installed in the lift shaft, and switching the linear drive into a safety operating state when the deceleration value above a predefined threshold value is determined by way of said monitoring.

The invention relates to a method for operating a lift system and a lift system.

In the field of lift design, the linear drive has now emerged as an alternative to the cable drive. Such a linear drive comprises stator units permanently installed in the lift shaft and at least one rotor unit permanently installed on the lift cage. The invention is applicable to a lift system that comprises a lift cage and such a linear drive for driving the lift cage. When moving upward, the lift cage must never be braked with more than the acceleration of gravity. A fastest possible deceleration safely within the limit value can be achieved in that the drive is set to neutral. If, in addition to the acceleration of gravity, further braking forces directed downward act on the lift cage, the lift cage is thus braked with a deceleration whose magnitude is greater than that of the acceleration of gravity. The rolling resistance of guide rollers can already generate this increased deceleration.

The significance of this to persons in the lift cage is the loss of ground contact and thus a significant risk of injury. In order for the braking to be comfortable for the passenger, the drive power is continuously reduced for braking; this results in a deceleration that is significantly lower than the acceleration of gravity.

A malfunction of the linear drive can firstly result in an interruption of the upward drive force, so that the lift cage is braked as a result of the Acceleration of gravity; secondly, a drive force acting downward on the lift cage can be generated suddenly by a short circuit. The lift cage is thus decelerated with more than the Acceleration of gravity, and the passenger is inevitably thrown head-first against the ceiling.

It is true that such a dangerous deceleration of the lift cage can be determined with an acceleration sensor attached to the lift cage. The deceleration value determined must, however, be transmitted very quickly to a safety apparatus that can initiate suitable safety measures. Wireless data transmission paths are increasingly used for signal transmission between a lift cage and units installed in the shaft, in order to be able to omit the traveling cable. Such traveling cables can no longer be used in lift systems with more than two cars per shaft. The existing wireless data transmission paths, WLAN for example, however delay the data transmission by important milliseconds, and are therefore too slow and thereby too unreliable.

### DISCLOSURE OF THE INVENTION

It is the object of the present invention to reduce the hazards referred to above. This is achieved through a method for operating a lift system as claimed in claim 1 and by a lift system as claimed in claim 4; preferred embodiments and advantages emerge from the subclaims and the following description, wherein the embodiments and advantages described are equally applicable to the method and to the device.

A method for operating a lift system is provided according to the invention. The lift system comprises a lift cage that is housed movably inside a lift shaft, and a linear drive for driving the lift cage. The linear drive comprises a stator arrangement fixedly attached to the lift shaft with a plurality of stators, and a rotor attached to the lift cage. The stator arrangement comprises a plurality of electromagnetic coils, each of which can be operated by one phase of a polyphase alternating current. The lift system in particular comprises a plurality, in particular more than two, lift cages that can be moved in a common lift shaft. The method comprises the following method steps:

providing the polyphase alternating current for operating the stator arrangement and thereby for driving the lift cage, in particular for providing an upward drive force for the lift cage,

monitoring a deceleration value of the lift system by means of sensors that are permanently installed in the lift shaft,

switching the linear drive into a safety operating state if a deceleration value above a predefined threshold value is determined in the monitoring step.

Through the use of sensors permanently installed in the lift shaft, both a wireless data transmission and a data transmission of the deceleration values via traveling cable can be omitted. The data transmission can consequently also take place over wires without a traveling cable, and thus be transmitted exceptionally quickly to a safety control apparatus that initiates suitable safety measures.

For monitoring, the progress of a phase angle of the polyphase alternating current is preferably measured, and a deceleration of the phase angle is calculated therefrom. Conclusions as to the deceleration of the lift cage can be determined immediately from the deceleration of the phase angle, since the phases directly generate the decelerating forces. The phase angle can be determined through monitoring the phase currents, which can be done locally, directly at the inverter, or at the connecting lines between the inverter and coils of the stators. The physical proximity to the responsible inverter also enables a fast, wired signal chain from the sensor to the inverter which, in appropriate circumstances, can be switched into a safety operating state.

As a result of elasticities in the controlled system (e.g. capacitors and inductances in the linear motor, sprung suspension of the rotor on the lift cage), a phase angle acceleration only brings about a deceleration (in the sense of a negative acceleration) of the lift cage after a certain time delay; by monitoring the phase angle delay, a deceleration of the lift cage can therefore be predicted a few milliseconds in advance, and valuable time for initiating safety measures can thus be gained.

For monitoring the deceleration value, current measuring instruments are preferably used as sensors to measure the phases of the polyphase alternating current are.

In addition to the elements referred to above, the lift system according to the invention comprises sensors designed for monitoring a deceleration value of the lift system, a control unit designed to switch the linear drive into a safety operating state if a deceleration value above a predefined threshold value is determined. The lift system according to the invention is characterized in that the sensors are permanently installed in the lift shaft.

The invention is explained in more detail below with reference to the figures; here

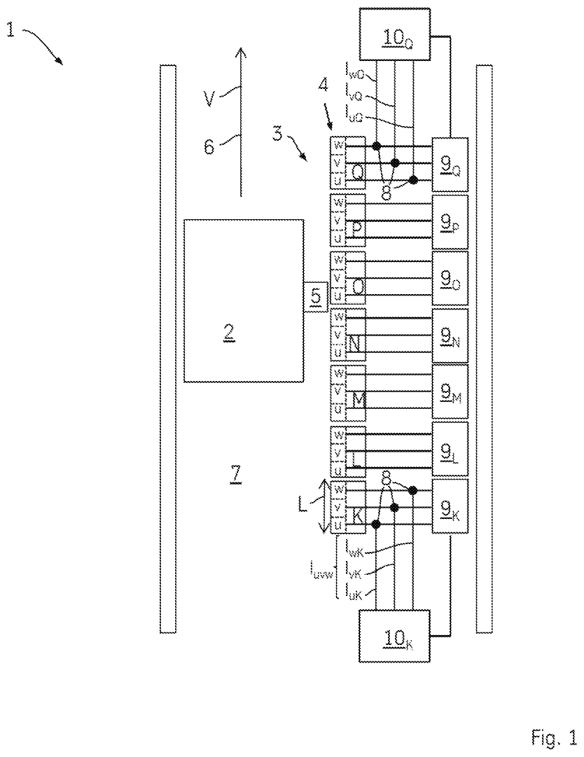

FIG. 1 shows schematically the construction of a lift system according to the invention with a linear motor;

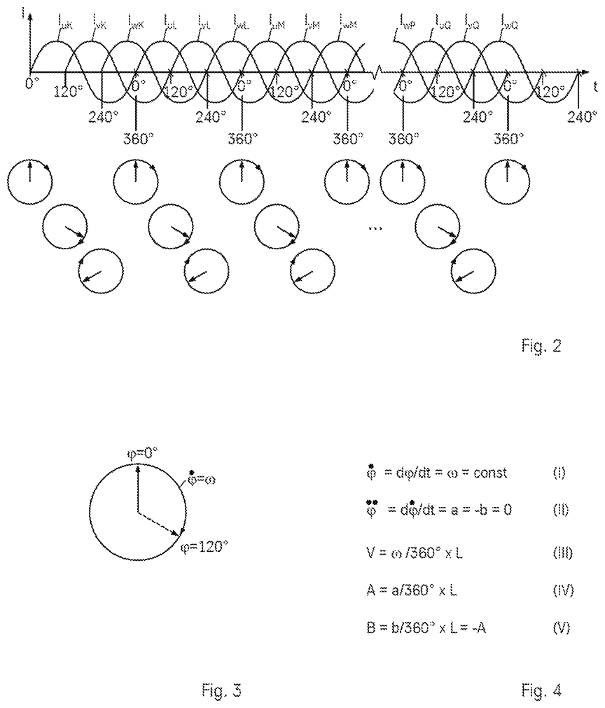

FIG. 2 shows the progress of the phases of a polyphase alternating current for operating the linear motor when moving upward at constant speed, with respective vector diagrams;

FIG. 3 shows a detailed view of one of the vector diagrams;

FIG. 4 shows the relevant mathematical relationships for the vector diagram;

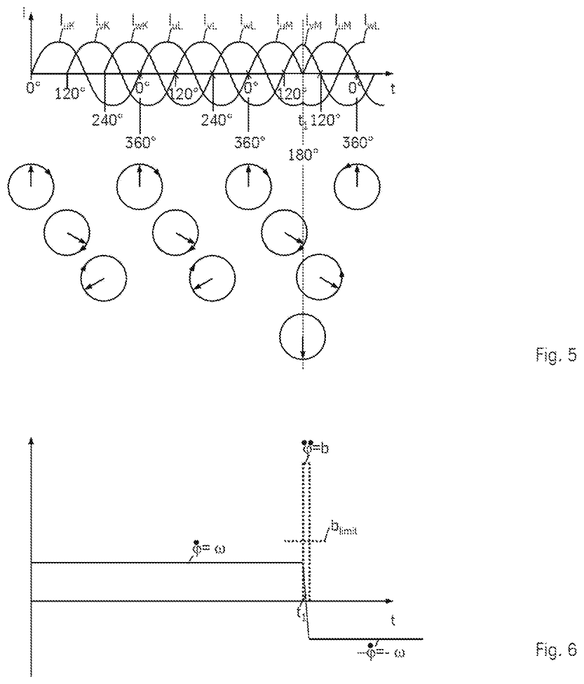

FIG. 5 shows the progress of the phases of the polyphase alternating current when moving upward with malfunction, with respective vector diagrams, without safety switch-off;

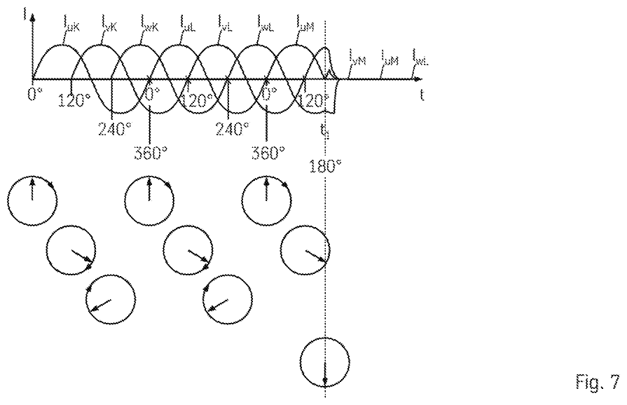

FIG. 6 shows the speed and the deceleration of the phases when moving upward with malfunction;

FIG. 7 shows the progress of the phases of the polyphase alternating current during an upward travel with malfunction, with respective vector diagrams, with safety switch-off.

FIG. 1 shows a lift system 1 according to the invention. This comprises a lift cage 2 that is housed in a vertically movable manner inside a lift shaft 7. The drive is provided by a linear motor 3 which comprises a stator arrangement 4 permanently installed in the shaft and a rotor 5 attached to the lift cage 2. The stator arrangement 4 comprises a plurality of stators K . . . Q, arranged one after another along the lift shaft 7 and operated by an associated inverter 9_{K} . . . 9₀. The inverters supply the associated stators K . . . Q with in each case a polyphase alternating current I_{UVW} with at least three phases I_{U}, I_{V}, I_{W}; individual coils u,v,w of the stators A . . . G are precisely each subjected to one phase current I_{U}, I_{V}, I_{W}. Further explanatory descriptions for driving a lift cage by means of a linear drive is, for example, disclosed in international patent application WO 2016/102385 A1, there in connection with a synchronous motor.

When the lift cage is moved upward in the direction of travel 6, the coils that are located within the region of influence of the rotor are systematically each subjected to one phase of the polyphase alternating current, as is shown in FIG. 2. The inverters 9 accordingly each generate a sequence of sinusoidal phase currents I_{U}, I_{V}, I_{W}, each of which is offset in phase by, in the case of 3-phase stators, 120°. The activations of the coils u,v,w of the second stator L here immediately follow the activations of the coils u,v,w of the first stator K. A moving magnetic field is thus generated by the coils u,v,w, which drives the rotor 5 onward.

FIG. 2 here shows the progress of the individual phase currents I_{uK}, I_{vK}, . . . I_{wQ}, during a travel at constant speed; the vector diagrams of the phases at the respective points in time are shown underneath.

FIG. 3 shows one of the vector diagrams at a larger scale, and serves to illustrate terminology used and mathematical relationships that are shown in FIG. 4. The vector points in a direction corresponding to the respective applicable phase angle of a stator. In the 12 o'clock position, the phase angle is 0°. The phase now changes with a phase angle speed φ “dot”=ω in the direction of phase angle 120°. The phase angle speed is constant, and is identified below as “ω” (I). The phase angle acceleration a and the phase angle deceleration b are accordingly 0 (II).

During the operation of an electric motor, in particular of a synchronous motor, the phase speed is synchronized to the speed of the rotor 3. Taking the length L of the stator (see FIG. 1) into account, the speed V of the rotor 3 depends linearly on the phase angle speed ω (III). Equally, the acceleration A, or the deceleration B, of the rotor depends linearly on the phase angle acceleration a or the phase angle deceleration b (I_{V}), (V).

In the context of the present invention, the deceleration b, B is always to be understood as the negative value of the acceleration a, A, and is thus a measure for the braking. The greater the deceleration B, b, the more strongly the associated speed value ω, V is braked from a positive value in the direction of 0. The deceleration B is the relevant value for when the lift cage is moved upward which represents the measure for the hazard mentioned in the introduction. The greater the deceleration B is (in a positive direction), the more strongly the passenger is thrown in the direction of the car ceiling. A deceleration of less than 0 means an acceleration of greater than 0 in the upward travel direction, which has the effect of an increased contact pressure on the feet of the passenger, and therefore does not result in him being thrown to the car ceiling.

In FIG. 5 a malfunction occurs at time t₁. The polarity is unintentionally reversed; the phases I_{Vm}, I_{uM} and I_{wL} thus run backward. The reversal of the phase angle speed ω at the phase angle of 180° can now be seen in the vector diagram. At this point in time, the phase angle deceleration b adopts a value significantly above threshold value b_{Limit}. The threshold value lies, for example, at 0.9. This necessarily results in an enormous deceleration of the lift cage 2. This lift cage deceleration is indeed not measured directly on the lift cage 2, but is deduced by monitoring the phase angles.

The monitoring of the phase angle speed ω is performed by current measuring instruments 8 at the respective phases, each of which has a wired connection to a safety control units 10_{A}, 10_{G}. For reasons of clarity, only the safety control units for the outer stators K, Q are drawn in FIG. 5. The safety control units 10_{A} . . . 10_{G} can also be grouped into one unit. In the event that an excessively large phase angle deceleration is determined, the safety control units 10 cause the respective inverters to be switched into a safety operation mode in which the massive deceleration is prevented. This connection is also wired, so that the signal chain from the sensors through to the inverter is very fast.

FIG. 5 here shows how the phases would proceed as from time t₁ without the safety switch-off, in order to demonstrate the hazard here. In the safety state, the coils u and v of the stator M and the coil w of the stator L are, for example, then switched off, so that the phases come at constant I=0 to a standstill. This is shown in FIG. 7.

A redundant, overlapping structure of the linear drive is fundamentally advantageous. In this case, the lift cage is driven by a plurality of stators simultaneously in every operating state. The redundant stators are here permanently mechanically coupled to one another. If a fault occurs at a stator or at its associated inverter, this thus results in an acceleration or deceleration of the rotating electric field of this stator. As a result of the inertia of the mass of the load (lift car) there is a change in the polar wheel angle (the principle of a synchronous electrical machine). Due to the change in the polar wheel angle, a change in the drive force (drive torque) also occurs. A soft coupling is therefore provided with redundant drive systems. If an unacceptable acceleration of a partial drive system is detected in the region of the soft coupling, this can thus be switched off individually.

If the polar wheel angle of 90° is exceeded, the drive can thus tip over. This can result in a change in the sign of the drive force (drive torque). Here, too, the partial drive segment concerned is switched off.

In a non-redundant drive concept, on the other hand, the deceleration of the lift cage is limited, in the event of switching off, to the acceleration of the gravity [exception] plus additional components resulting from power loss (rolling friction of the guide rollers, air resistance, etc.), which can cause the persons being carried to be slowly lifted. Strong further deceleration forces that can result in being forcefully thrown against the ceiling is avoided by switching off the linear drive.

### LIST OF REFERENCE SIGNS

1 Lift system
2 Lift cage
3 Linear drive
4 Stator arrangement
5 Rotor
6 Direction of travel
7 Lift shaft
8 Current measuring instrument
9 Inverter
10 Safety control unit
K . . . Q Stators
u, v, w Individual coils
L Length of a stator
V Speed of the rotor
A Acceleration of the rotor
B Deceleration of the rotor
φ Phase angle
ω Phase angle speed
a Phase angle acceleration (positive in the upward direction)
b Phase angle deceleration (positive in the downward direction)
I Current magnitude
I_{UVW} Polyphase alternating current
I_{U}, I_{V}, I_{W} Phases of the polyphase alternating current

1.-4. (canceled)

5. A method for operating a lift system having a lift cage movably housed inside a lift shaft and a linear drive configured to drive the lift cage, wherein the linear drive includes,
a stator arrangement fixedly attached to the lift shaft with a plurality of stators, the stator arrangement comprising a plurality of electromagnetic coils each configured to be operated by one phase of a polyphase alternating current, and
a rotor attached to the lift cage,
the method comprising:
providing the polyphase alternating current to operate the stator arrangement and thereby drive the lift cage to generate an upward drive force for the lift cage;
monitoring a deceleration value of the lift system with sensors that are permanently installed in the lift shaft by,
measuring the progress of a phase angle of the polyphase alternating current, and
calculating a deceleration of the phase angle therefrom; and
switching the linear drive into a safety operating state when the deceleration value above a predefined threshold value is determined by way of said monitoring.

6. (canceled)

7. The method of claim 5, wherein in the monitoring step, current measuring instruments are used as the sensors to measure the phases of the polyphase alternating current for monitoring the deceleration value.

8. (canceled)

9. A method for operating a lift system having a lift cage movably housed inside a lift shaft and a linear drive configured to drive the lift cage, wherein the linear drive includes,
a stator arrangement fixedly attached to the lift shaft with a plurality of stators, the stator arrangement comprising a plurality of electromagnetic coils each configured to be operated by one phase of a polyphase alternating current, and
a rotor attached to the lift cage,
the method comprising:
providing the polyphase alternating current to operate the stator arrangement and thereby drive the lift cage to generate an upward drive force for the lift cage;
monitoring a deceleration value of the lift system with sensors permanently installed in the lift shaft, wherein the sensors are current measuring instruments that measure the phases of the polyphase alternating current that correlate to the deceleration value of the lift system; and
switching the linear drive into a safety operating state when the deceleration value above a predefined threshold value is determined by way of said monitoring.
